(19) United States
(12) Patent Application Publication
(10) Pub. No.: US 2007/0275277 A1
(43) Pub. Date: Nov. 29, 2007

(54) Fuel cell and fuel supply module thereof

(75) Inventors: Chun-Wei Peng, Taoyuan Hsien (TW); Chih-Hung Wei, Taoyuan Hsien (TW); Chin-Yuan Chiu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/657,631

(22) Filed: Jan. 25, 2007

(30) Foreign Application Priority Data
Mar. 9, 2006 (TW) 095107895

(51) Int. Cl. H01M 8/04

(52) U.S. Cl. 429/14

(57) ABSTRACT

A fuel supply module, which is used for a fuel cell, includes a first substrate, a second substrate, and a separator. In this case, the first substrate has a reaction area. The second substrate has a supply channel and an exhaust channel, wherein the supply channel and the exhaust channel communicate with the reaction area. The separator disposed between the first substrate and the second substrate has a first through hole and a second through hole, wherein the supply channel communicates with the reaction area through the first through hole and the exhaust channel communicates with the reaction area through the second through hole.

### BACKGROUND OF THE INVENTION

1. Field of Invention

The invention relates to a fuel supply module and, in particular, to a fuel supply module for a fuel cell.

2. Related Art

A fuel cell is an electricity generation apparatus in which chemical energy is converted into electric power. Compared to the conventional method for generating electricity, fuel cells produce less pollution and less noise, and convert energy more efficiently. Because fuel cells generate electricity by way of oxidizing fuel, the amount of discharge current generated depends on the amount of fuel fed. If fuel and oxygen are fed without interruption, electricity can be generated continuously. Therefore, the fuel cell is a prospective clean energy source because it doesn't need to be linked to an electric grid and has no problem of electricity-related depletion of fossil fuels.

According to the different electrolytes, the developed fuel cell can be classified as an alkaline fuel cell (AFC), a phosphoric acid fuel cell (PAFC), a molten carbonate fuel cell (MCFC), a solid oxide fuel cell (SOFC), or a proton exchange membrane fuel cell (PEMFC).

With reference to FIG. 1, the PEMFC is taken as an example for illustration below. A conventional fuel cell 1 includes a base 10, at least one membrane electrode assembly (MEA) 11, a supply channel 12 and an exhaust channel 13. In this case, the MEA 11 includes a first electrode 111, a proton exchange membrane (PEM) 112, and a second electrode 113, disposed respectively on one surface of the base 10. The supply channel 12 and the exhaust channel 13 are formed within the base 10 and separately communicate with the MEA 11. In the direct methanol fuel cell (DMFC) of the PEMFC, methanol is supplied through the supply channel 12 as the fuel to the first electrode 111 undergoing an oxidation reaction to produce hydrogen ions (H⁺), electrons (e⁻) and carbon dioxide (CO₂). The hydrogen ions can diffuse to the second electrode 113 through the PEM 112. The electrons are coupled to a load and work through an external circuit connected with the first electrode 111, through which the electrons finally are delivered to the second electrode 113. The oxygen supplied to the second electrode 113 reacts with the hydrogen ions and electrons in a reduction reaction to produce water. In addition, the exhaust product, such as carbon dioxide, can be removed through the exhaust channel 13.

In order to obtain a higher operating voltage, a plurality of the fuel cells are connected in series to form a fuel cell module. Furthermore, the fuel cells can be connected in series as stacked-type or panel-type. However, the conventional fuel cell module is not easy to assemble and mass produce because of its structural complexity. In addition, the difficulty on reducing the weight and thickness of product is an obstacle to the current trend of developing lighter and smaller devices.

Therefore, it is an important subject of the invention to provide a fuel cell and a fuel supply module thereof that is smaller, more lightweight, and has a simpler structure.

### SUMMARY OF THE INVENTION

In view of the foregoing, the invention is to provide a fuel cell and a fuel supply module thereof having simpler structure, lighter weight and smaller size.

To achieve the above, the fuel supply module, which is used for a fuel cell, includes a first substrate, a second substrate, and a separator. In this case, the first substrate has a reaction area. The second substrate has a supply channel and an exhaust channel, wherein the supply channel and the exhaust channel communicate with the reaction area. The separator disposed between the first substrate and the second substrate has a first through hole and a second through hole, wherein the supply channel communicates with the reaction area through the first through hole and the exhaust channel communicates with the reaction area through the second through hole.

To achieve the above, the fuel cell comprises a fuel supply module and at least one membrane electrode set. In this case, the fuel supply module includes a first substrate, a second substrate, and a separator. The first substrate has a reaction area. The second substrate has a supply channel and an exhaust channel, wherein the supply channel and the exhaust channel communicate with the reaction area. The separator disposed between the first substrate and the second substrate has a first through hole and a second through hole, wherein the supply channel communicates with the reaction area through the first through hole and the exhaust channel communicates with the reaction area through the second through hole. The membrane electrode set is connected to the fuel supply module.

As mentioned above, a fuel cell and a fuel supply module thereof according to the invention are constructed by multilayer structure with simple channel design. Accordingly, the fuel is supplied through the supply channel to the reaction area for the ensuing reaction. The exhaust products of reaction or unused fuel can be discarded or recycled through the exhaust channel. In comparison with the conventional fuel cell, the fuel cell and the fuel supply module thereof of the invention have simpler structures and thus are more favorable for mass production. To satisfy a demand for higher operating voltage, it is easy to increase the number of the reaction areas and allow each reaction area to connect with the membrane electrode set, thus assembling a plurality of the fuel cells that form the fuel cell module. Furthermore, the fuel cell module can be designed lighter and smaller to follow the current trend.

### BRIEF DESCRIPTION OF THE DRAWINGS

The invention will become more fully understood from the detailed description given herein below illustration only, and thus is not limitative of the present invention, and wherein:

FIG. 1 is a schematic view showing a conventional fuel cell;

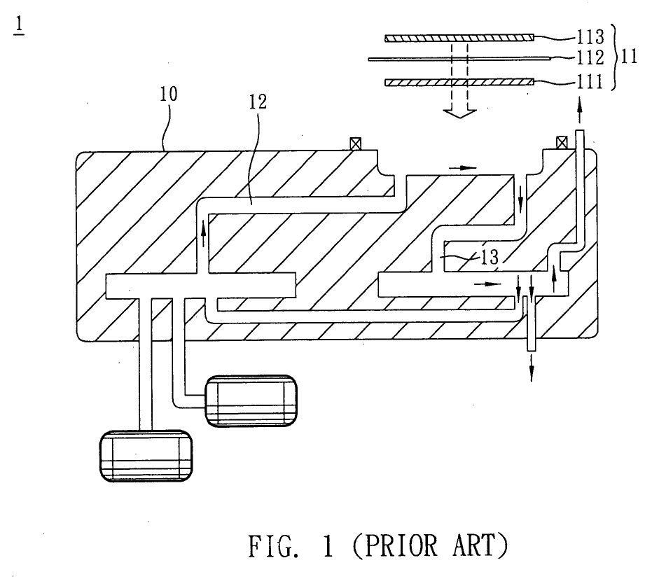

FIG. 2 is a schematic view showing a fuel supply module according to an embodiment of the invention;

FIG. 3 is a schematic view showing a fuel supply module according to another embodiment of the invention;

FIG. 4 is a schematic view showing a fuel supply module according to still another embodiment of the invention; and

FIG. 5 is a schematic view showing a fuel cell according to an embodiment of the invention.

### DETAILED DESCRIPTION OF THE INVENTION

The present invention will be apparent from the following detailed description, which proceeds with reference to the accompanying drawings, wherein the same references relate to the same elements.

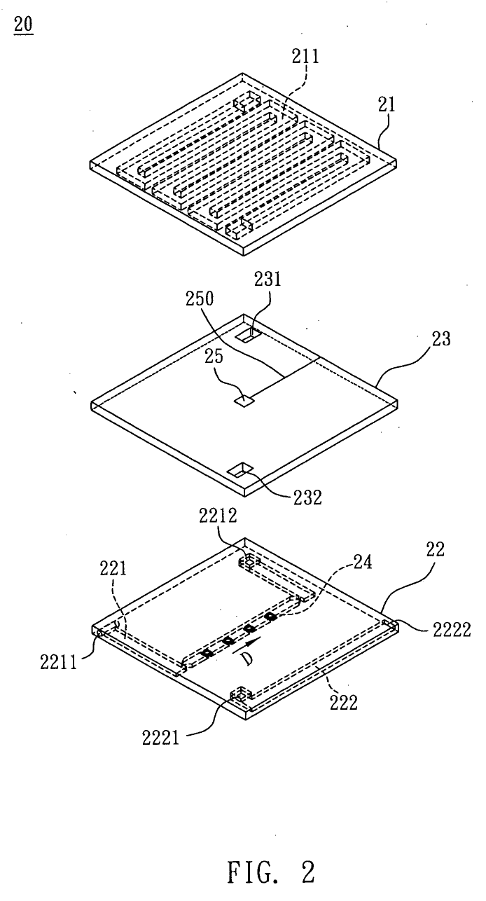

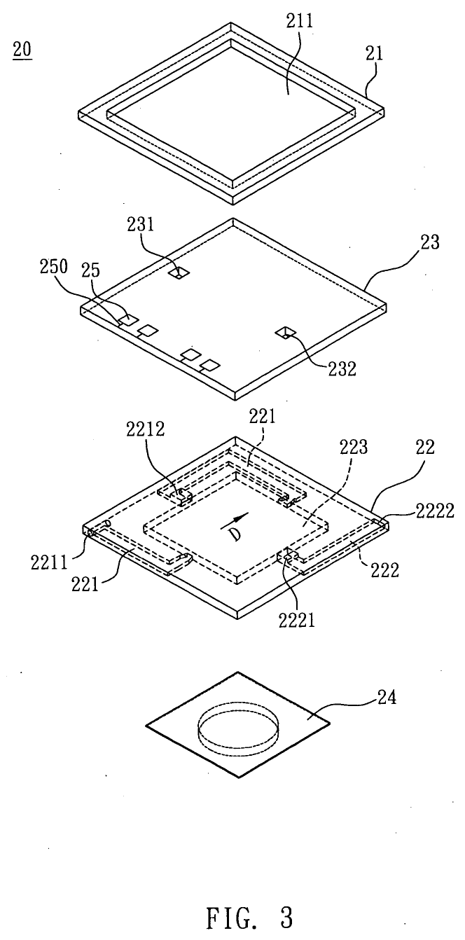

With reference to FIGS. 2 and 3, a fuel supply module 20 includes a first substrate 21, a second substrate 22, and a separator 23. In the present embodiment, the fuel supply module 20 is used for a fuel cell. The first substrate 21, the second substrate 22 or the separator 23 is made of a ceramic material and, for example, a low temperature co-fired ceramic (LTCC) substrate.

The first substrate 21 has a reaction area 211, which can be a channel as shown in FIG. 2 or a chamber as shown in FIG. 3. In this case, the channel can be a snake-like channel. However, the configuration of the reaction area 211 is not limited to the snake-type shown in FIG. 2.

The second substrate 22 has a supply channel 221 and an exhaust channel 222. The supply channel 221 has a first end 2211 and a second end 2212 and the exhaust channel 222 has a third end 2221 and a fourth end 2222.

The separator 23 is disposed between the first substrate 21 and the second substrate 22 and has a first through hole 231 and a second through hole 232. In the present embodiment, the first through hole 231 is disposed corresponding to the position of the second end 2212 of the supply channel 221 and the second through hole 232 is disposed corresponding to the position of the third end 2221 of the exhaust channel 222. Specifically, the first end 2211 of the supply channel 221 can be an inlet for the fuel. The fuel is fed through the inlet and into the supply channel 221. The fuel is delivered to the reaction area 211 through the first through hole 231. Afterwards, the reaction products can be removed by the exhaust channel 222 through the second though hole 232. In this case, the fuel can be a gas or a liquid.

The fuel supply module 20 further includes an actuator 24 disposed adjacent to the supply channel 221 for pumping the fuel to flow in a direction D. With reference to FIG. 2, the actuator 24 is disposed on at least one inner surface of the supply channel 221. In this case, the actuator 24 can be a micro pump, such as a piezoelectric element. The fuel in the supply channel 221 can be forced to proceed forward in the wriggling movement resulted from the deformation of the piezoelectric element.

With reference with FIG. 3, the second substrate 22 further includes an accommodation area 223. The accommodation area 223 can be a chamber serving as a fuel container from which a large quantity of fuel can be allowed to feed. The supply channel 221 is communicated to one lateral side of the accommodation area 223. The actuator 24 pumping the fuel to proceed forward is disposed on one outside surface of the accommodation area 223. As above mentioned, the actuator 24 can be a piezoelectric element, such as a diaphragm piezoelectric element. The deformation of the diaphragm driven by the piezoelectric element results in a pressure change in the accommodation area 223, which in turn forces the fuel to proceed forward. In addition, the exhaust channel 222 is communicated with the accommodation area 223 to recycle the reaction products.

With reference FIGS. 2 and 3, at least one portion of the supply channel 221 has a gradually decreasing cross-sectional area. More particularly, the cross sections of the portions of the supply channel 221 located ahead or behind the actuator 24 decrease gradually along the flow direction D of the fuel to increase the velocity of the fuel.

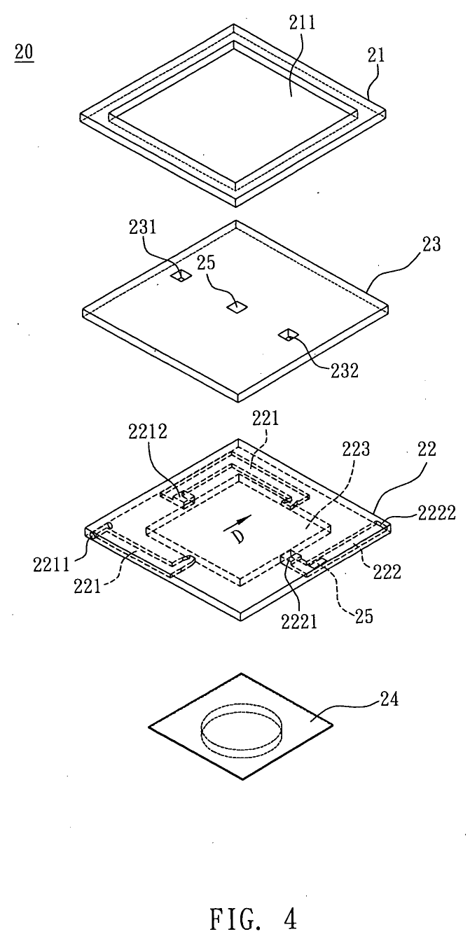

In the present embodiment, the fuel supply module 20 further includes at least one sensor 25. The sensor 25 is disposed on the separator 23 or on at least one inner surface of the exhaust channel 222 shown in FIG. 4. The location of the sensor 25 is not limited to the above mentioned areas. Additionally, the sensor 25 can be disposed on at least one inner surface of the supply channel 221. In this case, the sensor 25 can be a temperature sensor, a concentration sensor or a pressure sensor.

Furthermore, a signal transmission circuit 250 can be disposed on the separator 23 of the fuel supply module 20 to output a feedback signal to control temperature, concentration or pressure of the fuel.

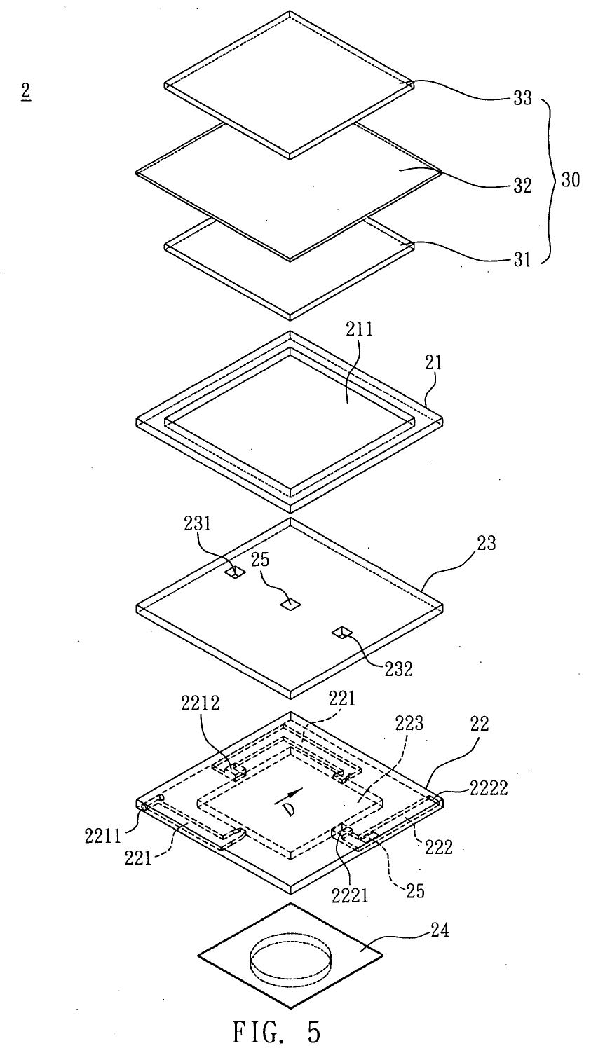

In addition, with reference to FIG. 5, a fuel cell 2 according to the embodiment of the invention includes a fuel supply module 20 and at least one membrane electrode set 30.

The fuel supply module 20 includes a first substrate 21, a second substrate 22 and a separator 23. In the present embodiment, the fuel supply module 20 further includes an actuator 24 and the second substrate 22 further includes an accommodation area 223. Because the architecture, structural characteristics, material and function of the first substrate 21, the second substrate 22, the separator 23, the actuator 24 and the accommodation area 223 in the present embodiment are the same as the elements described above so that the detailed is omitted for conciseness.

Furthermore, a corrosion resistant metal electrode is disposed adjacent to the reaction area 211 of the first substrate 21 (not shown). For example, the metal electrode can be disposed around the reaction area 211 in the chamber type as shown in FIG. 3 or disposed between the reaction areas 211 in the channel type as shown in FIG. 2.

The membrane electrode set 30 is formed on the first substrate 21 and connects to the fuel supply module 20. The membrane electrode set 30 includes a first electrode 31, a membrane 32 and a second electrode 33 combined in sequence. In this case, the membrane 32 is a proton exchange membrane. In the present embodiment, the first electrode 31 can be as an anode where the fuel is fed in while the second electrode 33 can be a cathode exposed to oxygen.

In order to help understand this invention more easily, the direct methanol fuel cell (DMFC) is taken as an example in the following. Methanol is fed as the fuel through the first end 2211 of the supply channel 221. The actuator 24 pumps the methanol fuel forward in direction D. Then, the methanol fuel passes through the first through hole 231 of the separator 23 into the reaction area 211, where the oxidation reaction occurs at the first electrode 31 of the membrane electrode set 30. Consequentially, hydrogen ions (H⁺), electrons (e⁻) and carbon dioxide (CO₂) are produced. Herein, the electrons are conducted to the second electrode 33 through the metal electrode. The hydrogen ions penetrate the membrane 32 to the second electrode 33. The hydrogen ions and electrons react with the oxygen supplied to the second electrode 33 in a reduction reaction producing water. However, un-reacted fuel and exhaust products, such as carbon dioxide, are diverted into the exhaust channel 222 through the second through hole 232 of the separator 23 to further be recovered for recycling or discarding. In addition, the sensors 25 disposed on the supply channel 221, the exhaust channel 222 or the separator 23 are provided to monitor the temperature, concentration or pressure of the fuel and transmit this information to the signal transmission circuit on the separator 23 which in turn can output a corresponding feedback control signal.

To obtain higher operating voltage, the fuel cell 2 can be assembled into panels or stacks in series to form a fuel cell module. Herein, the accommodation area 223 has a large volume and is disposed corresponding to the positions of a plurality of reaction areas 211. Therefore, a plurality of the membrane electrode assemblies 30 can be formed separately on each reaction area 211 and connected in series to form a panel-type fuel cell module. Alternatively, the membrane electrode set 30, the separator 23 and the first substrate 21 can be disposed sequentially on one first substrate 21 and connected in series to form a stacked-type fuel cell module.

In conclusion, a fuel cell and a fuel supply module thereof according to the invention are constructed with multilayer structure and simple channel design. The fuel is supplied through the supply channel to the reaction area for the ensuing reaction. The exhaust products of reaction or fuel can be disposed or recycled through the exhaust channel. In comparison with the conventional fuel cell, the fuel cell and the fuel supply module thereof of the invention have simpler structures more suitable to mass production. To satisfy the demand for a higher operating voltage, it is easy to increase the number of reaction areas and allow each reaction area connect with the membrane electrode set, thus assembling a plurality of the fuel cells into a fuel cell module. Furthermore, the design of the fuel cell module can be smaller and lighter to satisfy current trends.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A fuel supply module, which is used for a fuel cell, comprising:
a first substrate having a reaction area;
a second substrate having a supply channel and an exhaust channel; and
a separator disposed between the first substrate and the second substrate and having a first through hole and a second through hole, wherein the supply channel communicates with the reaction area through the first through hole, and the exhaust channel communicates with the reaction area through the second through hole.

2. The fuel supply module of claim 1, wherein the second substrate further comprises an accommodation area communicated with the supply channel and the exhaust channel, and the accommodation area is a chamber or a fuel container.

3. The fuel supply module of claim 2, further comprising an actuator disposed adjacent to the accommodation area or the supply channel for pumping a fuel.

4. The fuel supply module of claim 3, wherein the actuator is a piezoelectric element or a micro pump.

5. The fuel supply module of claim 1, wherein at least one portion of the supply channel has gradually decreasing cross sections.

6. The fuel supply module of claim 1, further comprising at least one sensor disposed on at least one side of the separator or the exhaust channel.

7. The fuel supply module of claim 6, wherein the sensor is a temperature sensor, a concentration sensor or a pressure sensor.

8. The fuel supply module of claim 6, wherein the sensor further comprises a signal transmission circuit outputting a feedback signal to control temperature, concentration or pressure of a fuel.

9. The fuel supply module of claim 1, wherein the reaction area is a channel or a chamber.

10. The fuel supply module of claim 1, wherein the first substrate, the second substrate or the separator is a low temperature co-fired ceramic substrate or is made of a ceramic material.

11. A fuel cell comprising:
a fuel supply module comprising a first substrate, a second substrate and a separator, wherein the first substrate has a reaction area, the second substrate has a supply channel and an exhaust channel, the separator is disposed between the first substrate and the second substrate and has a first through hole and a second through hole, the supply channel communicates with the reaction area through the first through hole, and the exhaust channel communicates with the reaction area through the second through hole; and
at least one membrane electrode set connected to the fuel supply module.

12. The fuel cell of claim 11, wherein the membrane electrode set comprises a first electrode, a membrane, and a second electrode combined in sequence, and the membrane is a proton exchange membrane.

13. The fuel cell of claim 11, wherein the second substrate further comprises an accommodation area communicated with the supply channel and the exhaust channel, and the accommodation area is a chamber or a fuel container.

14. The fuel cell of claim 13, further comprising an actuator, wherein the actuator is located adjacent to the accommodation area or the supply channel for pumping a fuel.

15. The fuel cell of claim 14, wherein the actuator is a piezoelectric element or a micropump.

16. The fuel cell of claim 11, wherein at least one portion of the supply channel has gradually decreasing cross sections.

17. The fuel cell of claim 11, further comprising at least one sensor disposed on at least one side of the separator or the exhaust channel.

18. The fuel cell of claim 17, wherein the sensor is a temperature sensor, a concentration sensor or a pressure sensor.

19. The fuel cell of claim 18, wherein the sensor further comprises a signal transmission circuit outputting a feedback signal to control temperature, concentration or pressure of a fuel.

20. The fuel cell of claim 11, wherein the first substrate, the second substrate or the separator is a low temperature co-fired ceramic substrate or is made of a ceramic material.
